(19) United States
(12) Patent Application Publication
(10) Pub. No.: US 2025/0256719 A1
(43) Pub. Date: Aug. 14, 2025

(54) VEHICLE AND A CONTROL METHOD THEREOF

(71) Applicants: HYUNDAI MOTOR COMPANY, Seoul (KR); KIA CORPORATION, Seoul (KR)

(72) Inventor: Sang Ho Shin, Hwaseong-si (KR)

(73) Assignees: HYUNDAI MOTOR COMPANY, Seoul (KR); KIA CORPORATION, Seoul (KR)

(21) Appl. No.: 18/955,044

(22) Filed: Nov. 21, 2024

(30) Foreign Application Priority Data
Feb. 13, 2024 (KR) 10-2024-0020271

(51) Int. Cl. B60W 30/16; B60W 30/02; B60W 30/09; B60W 30/14; B60W 30/18; G07C 5/00

(52) U.S. Cl. CPC B60W 30/16; B60W 30/02; B60W 30/09; B60W 30/146; B60W 30/18172; G07C 5/006; B60W 2554/802; B60W 2710/18; B60W 2720/106

(57) ABSTRACT

An autonomous vehicle may include a sensor module and a processor configured to control the sensor module and an advanced driver assistance system (ADAS). When the autonomous vehicle stops in a smart cruise control (SCC) mode, the processor may: measure an inter-vehicle distance, which is the distance between the autonomous vehicle and a vehicle ahead; compare the measured inter-vehicle distance with a preset reference safety distance; set a limiting mode to limit the driving of the autonomous vehicle based on the comparison and analysis results; and control the driving of the autonomous vehicle based on the set limiting mode.

### CROSS-REFERENCE TO RELATED APPLICATIONS

The present application claims priority to Korean Patent Application No. 10-2024-0020271, filed on Feb. 13, 2024, the entire contents of which are incorporated herein for all purposes by this reference.

### TECHNICAL FIELD

The present disclosure relates to an autonomous vehicle and a method of controlling the same, and, more particularly, to an autonomous vehicle and a method of controlling the same, which enable an advanced driver assistance system (ADAS) to operate stably even on unstable road surfaces.

### BACKGROUND

The statements in this section merely provide background information related to the present disclosure and may not constitute prior art.

Recently, the development of the advanced driver assistance system (ADAS) to ensure driver safety and provide driving convenience has accelerated.

The ADAS is a system that enables vehicles to drive safely and conveniently by controlling the steering, braking, acceleration/deceleration, and the like of the vehicles by using sensor data obtained by sensors such as cameras and radars.

However, the conventional ADAS is sometimes incapable of properly controlling vehicles. In other words, when a road surface is not normal, a vehicle may not be controlled as intended by the ADAS, resulting in an accident.

The information included in this Background of the present disclosure section is only to enhance understanding of the general background of the present disclosure and may not be taken as an acknowledgement or any form of suggestion that this information forms the prior art already known to a person having ordinary skill in the art.

### SUMMARY

The present disclosure is aimed at providing an autonomous vehicle and a method of controlling the same that are capable of preventing accidents due to unstable road surfaces by stably controlling an advanced driver assistance system (ADAS) regardless of road surface conditions.

The technological problems to be solved through the present disclosure are not limited to those mentioned above. The following description should enable a person having ordinary skill in the art to clearly understand other technological problems not mentioned above.

To resolve the aforementioned technological problems, an embodiment of the present disclosure provides a method of controlling a vehicle. The method may include determining, by a controller, that a first condition or a second condition is satisfied while the vehicle is controlled in a smart cruise control (SCC). The method may also include controlling, by the controller, driving of the vehicle in a set limiting mode for the first condition or the second condition.

The first condition may include a condition that another advanced driver assistance system (ADAS) control is operated in a number of times equal to or over a predetermined reference number.

The other ADAS control may include an electronic stability control (ESC) or a traction control system (TCS).

The predetermined reference number may include a first reference number and a second reference number. The set limiting mode may include a first limiting mode, a second limiting mode, or a third limiting mode based on the first reference number and the second reference number.

Controlling the driving of the vehicle in the set limiting mode may include controlling the vehicle in the first limiting mode when the number of times is less than or equal to the first reference number and may include maintaining a determined acceleration or a time to collision (TTC) based on the set first limiting mode.

Controlling the driving of the vehicle may include controlling the vehicle in the second limiting mode when the number of times is greater than the first reference number and is less than or equal to the second reference number and may include changing the determined acceleration based on the set second limiting mode or switching to a first TTC so that a braking control time is ahead of the TTC.

Controlling the driving of the vehicle may include controlling the vehicle in the third limiting mode when the number of times is greater than the second reference number and may include changing the determined acceleration based on the set third limiting mode or switching to a second TTC so that the braking control time is ahead of the first TTC.

Controlling the driving of the vehicle may further include turning off the SCC and outputting an alarm regarding inspection and replacement of tires based on the third limiting mode.

The second condition may include a condition that, when the vehicle stops in the SCC, a distance between the vehicle and another vehicle ahead of the vehicle is equal to or smaller than a predetermined reference safety distance.

The predetermined reference safety distance may include a first safety distance and a second safety distance. The set limiting mode may include a first limiting mode, a second limiting mode, or a third limiting mode based on the first safety distance and the second safety distance.

Controlling the driving of the vehicle in the set limiting mode may include controlling the vehicle in the first limiting mode when the distance is less than or equal to the first safety distance and may include maintaining a determined acceleration or a time to collision (TTC) based on the set first limiting mode.

Controlling the driving of the vehicle in the set limiting mode may include controlling the vehicle in the second limiting mode when the distance is greater than the first safety distance and is less than or equal to the second safety distance; and may include changing the determined acceleration based on the set second limiting mode or switching to a first TTC so that a braking control time is ahead of the TTC.

Controlling the driving of the vehicle in the set limiting mode may include controlling the vehicle in the third limiting mode when the distance is greater than the second safety distance and may include changing the determined acceleration based on the set third limiting mode or switching to a second TTC so that the braking control time is ahead of the first TTC.

Controlling the driving of the vehicle in the set limiting mode may include turning off the SCC and outputting an alarm regarding inspection and replacement of tires to be output.

A vehicle, according to an embodiment of the present disclosure, may include a sensor module configured to sense environment around the vehicle, an advanced driver assistance system (ADAS) configured to implement ADAS controls including a smart cruise control (SCC), and a controller. The controller may be configured to control the sensor module and the ADAS to determine that a first condition or a second condition is satisfied while the vehicle is controlled in the SCC, and control driving of the vehicle in a set limiting mode for the first condition or the second condition.

The first condition may include a condition that another ADAS control is operated in a number of times equal to or over a predetermined reference number.

The other ADAS control may include an electronic stability control (ESC) or a traction control system (TCS).

The predetermined reference number may include a first reference number and a second reference number. The set limiting mode may include a first limiting mode, a second limiting mode, or a third limiting mode based on the first reference number and the second reference number.

The controller may be further configured to control the vehicle in the first limiting mode when the number of times is less than or equal to the first reference number and to maintain a determined acceleration or a time to collision (TTC) based on the set first limiting mode.

The second condition may include a condition that, when the vehicle stops in the SCC, a distance between the vehicle and another vehicle ahead of the vehicle is equal to or smaller than a predetermined reference safety distance.

In the case of the autonomous vehicle and the method of controlling the same according to embodiments of the present disclosure as described above, it may be possible to stably control the ADAS regardless of road surface conditions, preventing accidents due to unstable road surfaces.

In addition, in the case of the autonomous vehicle and the method of controlling the same according to embodiments of the present disclosure, it may be possible to stably control the ADAS regardless of road surface conditions and to activate a braking control at the same time in advance and at an appropriate time, enabling the autonomous vehicle to be driven in a more stable manner.

The effects of the present disclosure are not limited to those mentioned above. The following description should enable a person having ordinary skill in the art to clearly understand other effects not mentioned above.

The methods and apparatuses of the present disclosure may have other features and advantages that should be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram for illustrating an autonomous vehicle according to an embodiment of the present disclosure.

FIG. 2 and FIGS. 3A-3C are views for illustrating a method of driving an autonomous vehicle according to a first embodiment of the present disclosure.

FIG. 4 and FIGS. 5A and 5B are views for illustrating a method of driving an autonomous vehicle according to a second embodiment of the present disclosure.

FIG. 6 is a view for illustrating a method of driving an autonomous vehicle according to a third embodiment of the present disclosure.

It may be understood that the appended drawings are not necessarily drawn to scale, presenting a somewhat simplified representation of various features illustrative of the basic principles of the present disclosure. The specific design features of the present disclosure as included herein, including, for example, specific dimensions, orientations, locations, and shapes, will be determined in part by the particularly intended application and use environment.

In the figures, the same reference numerals refer to the same or equivalent parts of the present disclosure throughout the several figures of the drawings.

### DETAILED DESCRIPTION OF ILLUSTRATIVE EMBODIMENTS

Hereinafter, with reference to the attached drawings, embodiments of the present disclosure are described in detail to allow a person having ordinary skill in the art to carry out them. However, the present disclosure can be carried out in various forms and is not limited to the embodiments described herein. In addition, in order to clearly describe the technical concepts of the present disclosure, parts not related to the description have been omitted from the drawings, and similar drawing reference numerals have been given to similar parts throughout the present disclosure.

Throughout the present disclosure, when a certain part is described to “include,” “comprise,” or “have” a certain component, it does not mean that the part excludes other components but instead means that the part may further include other components, unless specifically stated to the contrary. Furthermore, throughout the present disclosure, parts given the same reference numbers refer to the same components.

In addition, the terms “unit” and “control unit” in names such as a vehicle control unit (VCU) are only terms widely used to name a controller for controlling a certain function of a vehicle, and do not mean a generic function unit. For example, each controller may include a communication device that communicates with other controllers or sensors to control a function that the controller is responsible for, a memory that stores an operating system, logic instructions, input/output information, and the like, and one or more processors that perform operations of determination, calculation, making decisions, and the like required to control the function.

When a component, controller, processor, module, unit, device, element, apparatus, or the like of the present disclosure is described as having a purpose or performing an operation, function, or the like, the component, controller, processor, module, unit, device, element, apparatus, or the like should be considered herein as being “configured to” meet that purpose or to perform that operation or function. Each component, controller, processor, module, unit, device, element, apparatus, and the like may separately embody or be included with a processor and a memory, such as a non-transitory computer readable media, as part of the apparatus.

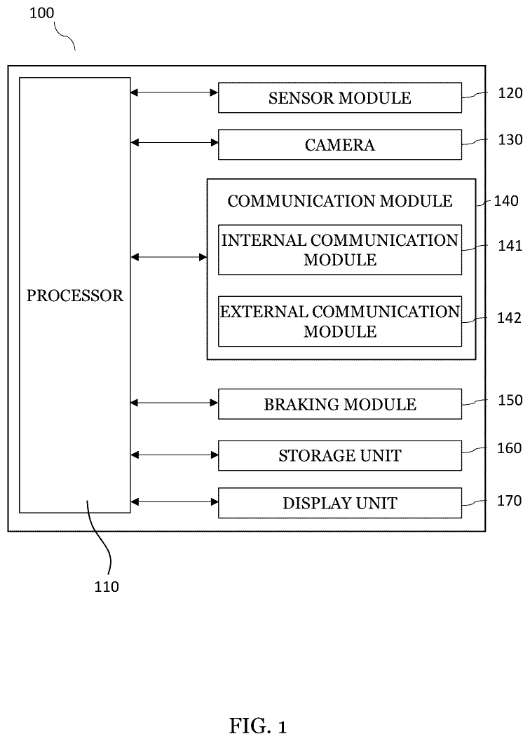

FIG. 1 is a block diagram for illustrating an autonomous vehicle according to an embodiment of the present disclosure.

Referring to FIG. 1, an autonomous vehicle 100 according to an embodiment of the present disclosure may include a processor 110, a sensor module 120, a camera 130, a communication module 140, a braking module 150, a storage unit 160, and a display unit 170.

The processor 110 may be disposed in the autonomous vehicle 100 and electrically connected to at least one component, module, and the like mounted on the autonomous vehicle 100. The processor 110 may control the autonomous vehicle 100 as a whole while exchanging various data, signals, and the like with the at least one component, module, and the like electrically connected thereto through wired or wireless communication.

For example, the components of the autonomous vehicle 100 may exchange signals or data with each other through an internal communication module 141, which is the communication module 140 of the autonomous vehicle 100, under the control of the processor 110. For example, the internal communication module 141 of the autonomous vehicle 100 may include at least one communication protocol, such as CAN, LIN, FlexRay, media oriented systems transport (MOST), and Ethernet.

The processor 110 may control the autonomous vehicle 100 by controlling other components mounted on the autonomous vehicle 100. For example, the processor 110 may serve as at least one of an engine management system (EMS), an electronic stability control (ESC), an electronic stability program (ESP), a Vehicle Dynamic Control (VDC), a lane keeping assistance system (LKAS), a smart cruise control (SCC), an adaptive cruise control (ACC), an autonomous emergency braking (AEB), a forward collision-avoidance assist (FCA), a highway driving assist (HAD), a highway driving pilot (HDP), a lane departure warning (LDW), a driver awareness warning (DAW), a driver state warning (DSW), and a traction control system (TCS). The above-mentioned functions can be referred to as an advanced driver assistance system (ADAS).

The processor 110 may sense and count the operation of the advanced driver assistance system (ADAS) when a smart cruise control (SCC) mode is turned on while a vehicle is driving.

The processor 110 may compare the number of counted times the ADAS is operated with a reference number, which has been preset. The processor 110 may set a limiting mode to limit the driving of the autonomous vehicle based on the comparison result. The processor 110 may control the driving of the autonomous vehicle based on the set limiting mode.

In addition, when the autonomous vehicle stops in the smart cruise control (SCC) mode, the processor 110 may measure an inter-vehicle distance, which is the distance between the autonomous vehicle and a vehicle ahead.

The processor 110 may compare the measured inter-vehicle distance with a reference safety distance, which has been preset. The processor 110 may set the limiting mode to limit the driving of the autonomous vehicle based on the comparison result. The processor 110 may control the driving of the autonomous vehicle based on the set limiting mode.

A detailed description of the processor 110 is provided below.

The sensor module 120 may be mounted on the autonomous vehicle 100 and sense at least one object around the autonomous vehicle 100. Examples of the object may include other cars (e.g., a vehicle in front, a vehicle ahead, a vehicle behind, and a following vehicle), pedestrians, obstacles, and vehicles (e.g. bicycles, e-scooters, e-bikes, motorcycles, and e-wheels).

For example, by using at least one sensor, the sensor module 120 may secure precise information on an object, including the location of the object, distance from the autonomous vehicle 100 to the object, direction in which the object is away from the autonomous vehicle 100, direction in which the object is moving, the speed of the object, and the like.

For example, under the control of the processor 110, the sensor module 120 may accurately sense a change in the positional relationship between the autonomous vehicle 100 and an object by using at least one sensor. The at least one sensor may be a radar sensor, a light detection and ranging (LiDAR) sensor, an infrared sensor, an ultrasonic sensor, a laser sensor, and the like. For example, the laser sensor may use a time-of-flight (TOF) method or/and a phase-shift method based on how to modulate laser signals in order to accurately measure the positional relationship between the autonomous vehicle 100 and an object.

For example, when the autonomous vehicle 100 stops in the smart cruise control (SCC) mode, under the control of the processor, the sensor module 120 may sense or measure an inter-vehicle distance, which is the distance between the autonomous vehicle 100 and a vehicle ahead.

Under the control of the processor 110, the sensor module 120 may sense an object in at least one of the front, rear, left, and right areas of the autonomous vehicle 100 by using at least one sensor. The at least one sensor may be mounted at various locations in the autonomous vehicle 100. For example, the at least one sensor may be mounted on at least one of the front, rear, left, right, and ceiling of the autonomous vehicle 100.

In addition, when there are multiple objects, it may be possible for the sensor module 120 to sense the multiple objects simultaneously. Not limited thereto, the sensor module 120 may sense the objects under the control of the processor 110 and may set a target object among the multiple objects by considering the speed of the objects, the distance between the objects and the autonomous vehicle 100, the size of the objects, and the like. The sensor module 120 may sense and track the set target object with priority over other objects under the control of the processor 110.

Examples of the at least one sensor may include a heading sensor, a yaw sensor, a gyro sensor, a sense for sensing a vehicle's forward/reverse movement, a wheel sensor, a vehicle speed sensor, a vehicle body tilt sensor, a battery sensor, a fuel sensor, a tire sensor, a steering sensor by turning a steering wheel, a vehicle internal temperature sensor, a vehicle internal humidity sensor, a door sensor, and the like.

The camera 130 may collect images of the surroundings of the autonomous vehicle 100 or images of the interior of the autonomous vehicle 100. At least one camera 130 may be mounted on the autonomous vehicle 100 to collect images of the front, rear, and side of the autonomous vehicle 100.

The camera 130 may provide the collected images to the processor 110. For example, the processor 110 may analyze images collected through the camera 130 and process still images or moving images and may extract necessary image information from the processed still or moving images.

For example, the camera 130 may include a charge coupled device (CCD) image sensor or a complementary metal oxide semiconductor (CMOS) image sensor. The camera 130 may include a sensor for perceiving a three-dimensional space, such as KINECT (red, green, blue and depth (RGB-D) sensor), TOF sensor (structured light sensor), and a stereo camera.

The communication module 140 may communicate with one or more base stations, external devices, or other vehicles. The other vehicles may be a vehicle in front of the autonomous vehicle 100 in motion, a vehicle ahead, a vehicle behind, a vehicle following the vehicle, a vehicle on the side of the vehicle, and the like.

The communication module 140 may receive driving information from other vehicles under the control of the processor 110. The driving information may include the location, speed, acceleration, direction, predicted path, and path history of other vehicles, a forward collision-avoidance assist (FCA) signal (hereinafter, referred to as a “FCA operation signal (FRONT_FCA_ACT)”), and the like.

For example, the communication module 140 may include the internal communication module 141 and an external communication module 142.

The internal communication module 141 may perform the operation of transmitting or receiving by using various communication protocols within the autonomous vehicle 100. The communication protocols may include at least one of a controller area network (CAN), a CAN with flexible data rate (CAN FD), Ethernet, a local interconnect network (LIN), and FlexRay. The communication protocol may include another protocol for communication between various devices disposed in a vehicle.

The external communication module 142 may perform a vehicle-to-vehicle (V2V) communication with another vehicle or a Vehicle-to-Infrastructure (V2I) communication with an infrastructure system. The infrastructure system may be a roadside unit or server that periodically transmits traffic information in conjunction with a transportation information system (TIS), an intelligent transport system (ITS), and the like.

Not limited thereto, the external communication module 142 may perform a vehicle-to-everything (V2X) communication. The external communication module 142 may use a range of communication methods, such as a vehicular ad hoc network (VANET), wireless access in vehicular environments (WAVE), dedicated short-range communication (DSRC), a communication access in land mobile (CALM), a vehicle-to-network (V2N), wireless LAN (WLAN) communication, wireless-fidelity (Wi-Fi) communication, wireless broadband (WiBro) communication, long term evolution (LTE) communication, long term evolution-advanced (LTE-A) communication, 5G communication, 6G communication, ultra-wideband (UWB) communication, ZigBee communication, and near field communication (NFC) communication.

The communication module 140 may include at least one of a transmitting antenna, a receiving antenna, and a radio frequency (RF) circuit and element for operating various communication protocols.

In addition, the communication module 140 may communicate with an occupant's terminal.

The braking module 150 may brake the autonomous vehicle 100 in motion under the control of the processor 110. When a braking signal is provided, the braking module 150 may suddenly or gradually brake the autonomous vehicle 100 in response to the braking signal under the control of the processor 110. The braking signal may include information on a signal of a time-to-collision (TTC) with a vehicle in front of or behind the autonomous vehicle 100 (hereinafter, referred to as a “TTC signal”).

The braking module 150 may gradually reduce the speed of the autonomous vehicle 100 or suddenly stop it based on a braking signal, under the control of the processor 110.

For example, the braking module 150 may include a plurality of wheel brakes (front-left (FL), front-right (FR), rear-left (RL), and rear-right (RR)).

For example, the plurality of wheel brakes (FL, FR, RL, and RR) may include a first wheel brake (FL) for stopping a front left wheel of the autonomous vehicle 100, a second wheel brake (FR) for stopping a front right wheel thereof, a third wheel brake (RL) for stopping a rear left wheel thereof, and a fourth wheel brake (RR) for stopping a rear right wheel thereof.

The plurality of wheel brakes may each be installed corresponding to their respective wheels of the autonomous vehicle 100. For example, each of the plurality of wheel brakes (FL, FR, RL, and RR) may be controlled separately and generate a braking force to their respective wheels.

The storage unit 160 may be mounted on or removed from the interior of the autonomous vehicle 100. The storage unit 160 may store programs and information necessary for controlling an advanced driver assistance system (ADAS). The storage unit 160 may store information sensed by the sensing module, image information collected by the camera 130, information generated by the processor 110, information received by the communication module 140, and the like. It is not limited thereto. The storage unit 160 may be referred to as a memory.

The display unit 170 may be mounted inside the autonomous vehicle 100. The display unit 170 may display a driving assistance system related to the autonomous vehicle 100 under the control of the processor 110. For example, the display unit 170 may include a cluster.

For example, when a vehicle ahead suddenly slows down, the risk of collision with a stopped vehicle, pedestrian, bicycle, or passenger in front is sensed, or a road surface on which the vehicle is driving is unstable, the display unit 170 may display information thereon under the control of the processor 110. The display unit 170 may output a warning sound, and the like in some cases.

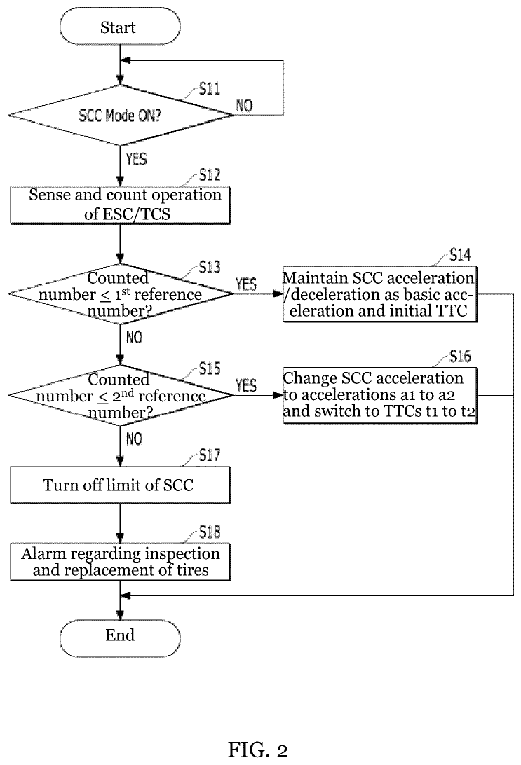

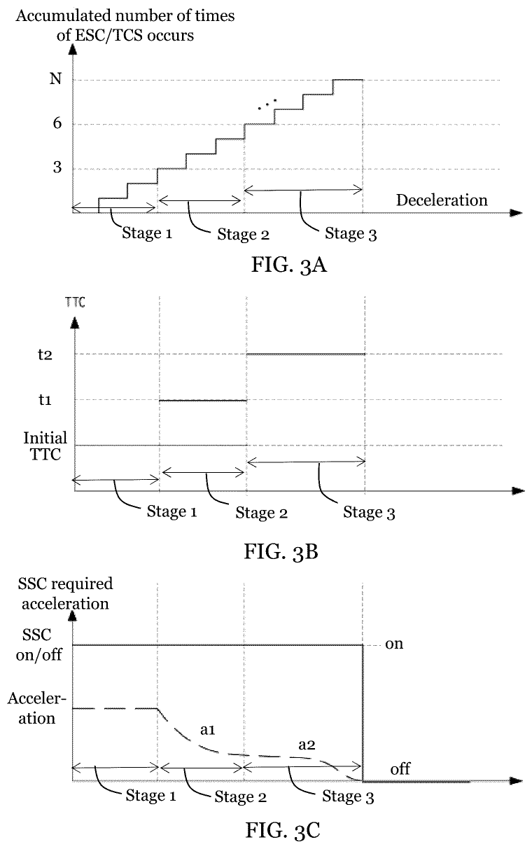

FIG. 2 and FIGS. 3A-3C are views for illustrating a method of driving an autonomous vehicle according to a first embodiment of the present disclosure.

Referring to FIG. 2 and FIGS. 3A-3C, a method of controlling the autonomous vehicle including a processor according to the first embodiment of the present disclosure is as follows.

The autonomous vehicle may determine whether a smart cruise control (SCC) mode has been turned on while driving under the control of a processor at S11.

When the smart cruise control (SCC) mode is turned on while the autonomous vehicle is traveling, the autonomous vehicle may sense and count the operation of an advanced driver assistance system (ADAS), under the control of a processor at S12.

The advanced driver assistance system (ADAS) may include an electronic stability control (ESC) or a traction control system (TCS). The electronic stability control (ESC), which is an electronic vehicle body stability control device, may calculate the speed, rotation, slippage, and the like of a driving vehicle in tenths of a second and compare actual values with a driver's intended values. When there is a difference between the actual values and the intended values, the ESC may intervene to control brakes, engine power, and the like as intended by the driver to prevent an accident. When engine output (torque) is too strong compared to wheel grip or tires slip on an icy road, the capability to accelerate will not work properly. Therefore, the traction control system (TCS) may serve to reduce skidding by appropriately limiting engine power or applying brakes to a slipping wheel.

When the smart cruise control (SCC) mode is turned on while the autonomous vehicle is traveling, under the control of the processor, the autonomous vehicle may sense the operations of the ESC or the TCS and may count and accumulate the sensed operation of the ESC or the TCS.

For example, as shown in FIG. 3A, FIG. 3B, and FIG. 3C, the processor may perform flag counting (within a cycle of N startups) during the operation of the ESC or the TCS.

The processor may lower a SCC mode required acceleration by ‘a’ % (a=preset value) according to the number of operations of the ESC or the TCS.

Under the control of the processor, the autonomous vehicle may compare the number of counted times the ESC or the TCS is operated with one or more predetermined reference numbers, and may set a limiting mode to limit the driving of the autonomous vehicle based on the comparison result at S13 and S15.

The predetermined reference numbers may include a first reference number, a second reference number, and a third reference number. In addition, the set limiting mode may include a first limiting mode, a second limiting mode, and a third limiting mode.

As one example embodiment, the first reference number may be 2, and the processor may check whether the first condition of the number of occurrences of ESC/TCS≤2 is satisfied. When the first condition is satisfied, the processor may set the limiting mode into the first limiting mode. In the first limiting mode, which may be the first stage of limiting control, a road surface may be determined to be normal and the vehicle may accelerate to an existing required acceleration (a0). The second reference number may be 5, and the processor may check whether the number of occurrences of ESC/TCS is greater than 2 (the first reference number) and equal to or smaller than 5 (the second reference number), i.e. whether the second condition of 2<the number of occurrences of ESC/TCS≤5 is satisfied. When the second condition is satisfied, the processor may set the limiting mode into the second limiting mode. In the second limiting mode, which may be the second stage of limiting control, a road surface may be determined to be slippery and the vehicle may accelerate to acceleration a1, which may be lower than a0 by a predetermined amount. The third reference number may be 6, and the processor may check whether the number of occurrences of ESC/TCS is equal to or greater than 6 (the third reference number), i.e. whether the third condition of 6≤the number of occurrences of ESC/TCS is satisfied. When the third condition is satisfied, the processor may set the limiting mode into the third limiting mode. In the third limiting mode, which may be the third stage of limiting control, a road surface may be determined to be very poor, the vehicle may accelerate to acceleration a2, and a message may be sent to limit the SCC function.

For example, under the control of the processor, the autonomous vehicle may set one of the first limiting mode, the second limiting mode, and the third limiting mode to limit the driving of the autonomous vehicle based on the analysis results.

Under the control of the processor, the autonomous vehicle may set the first limiting mode at S14 when the number of times the ADAS is operated is less than or equal to the first reference number at S13. The autonomous vehicle may maintain a required acceleration or current time to collision (TTC) (e.g., initial TTC, or exiting TTC) based on the set first limiting mode under the control of the processor at S14.

In addition, under the control of the processor, the autonomous vehicle may set the second limiting mode at S16 when the number of times the ADAS is operated is greater than the first reference number and is less than or equal to the second reference number at S15. Under the control of the processor, the autonomous vehicle may change a required acceleration based on the set second limiting mode or may switch to a first time to collision so that a braking control time is ahead of the current time to collision (TTC) at S16.

Under the control of the processor, the autonomous vehicle may set the third limiting mode when the number of times the ADAS is operated is greater than the second reference number and may change a required acceleration based on the set third limiting mode or may switch to a second time to collision so that a braking control time is ahead of the first time to collision.

In addition, under the control of the processor, the autonomous vehicle may turn off the smart cruise control (SCC) mode while switching to the second time to collision based on the set third limiting mode at S17.

Furthermore, at S18, under the control of the processor, the autonomous vehicle may allow an alarm regarding inspection and replacement of its own tires to be output when the SCC mode has been turned off.

The autonomous vehicle may control its own driving based on a set limiting mode under the control of the processor.

As described above, when the SCC mode has been turned on, under the control of the processor, the autonomous vehicle according to the first embodiment of the present disclosure may check the accumulated numbers of times the ESC or the TCS is operated to adjust a SCC acceleration and TTC based on a history of the occurrence thereof and may limit the operation of the SCC when necessary.

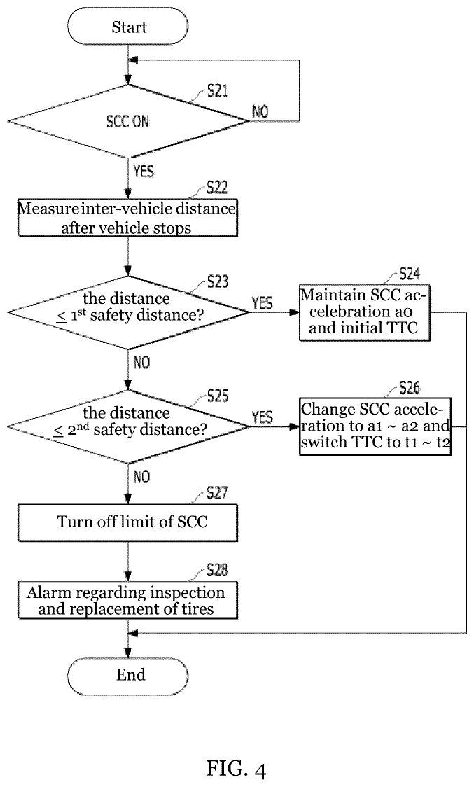

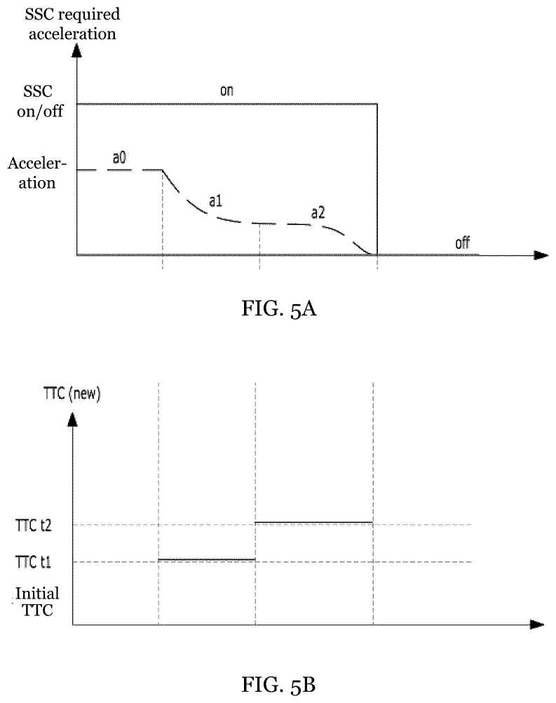

FIG. 4 and FIGS. 5A and 5B are views for illustrating a method of driving an autonomous vehicle according to a second embodiment of the present disclosure.

Referring to FIG. 4 and FIGS. 5A and 5B, a method of controlling the autonomous vehicle including a processor according to the second embodiment of the present disclosure is as follows.

The autonomous vehicle may determine whether a smart cruise control (SCC) mode has been turned on while driving under the control of a processor at S21.

Under the control of the processor, when the autonomous vehicle stops while driving in the SCC mode, it may measure an inter-vehicle distance, which is the distance between the autonomous vehicle and a vehicle ahead, at S22. The inter-vehicle distance may be a value, which has been measured at least once. The processor may analyze the inter-vehicle distance measured at least once to determine an average inter-vehicle distance and a minimum inter-vehicle distance and may set a reference safety distance based on the determined inter-vehicle distances at S23 and S24.

For example, the average inter-vehicle distance may be an average value of inter-vehicle distances of n times of SCC starting and stopping. This can be expressed in Equation 1 as follows:

$$Navg = ( k 1 + k 2 + …… Kn ) / n times \qquad [ Equation 1 ]$$

In Equation 1, Navg indicates the average inter-vehicle distance which may be set as 2 meters for example, and the minimum inter-vehicle distance (N) may be set as 2.7 meters for example.

The autonomous vehicle may compare a measured inter-vehicle distance with a preset reference safety distance under the control of the processor.

In addition, the preset safety distance may include a first safety distance and a second safety distance. For example, the first safety distance may be 3.5 m≤N(avg)≤4 m. The second safety distance may be 2.7≤N(avg)≤3.5. It is not limited thereto and may vary depending on a measured inter-vehicle distance.

Under the control of the processor, the autonomous vehicle may set a limiting mode to limit the driving of the autonomous vehicle based on the comparison results.

Under the control of the processor, the autonomous vehicle may set a first limiting mode or a second limiting mode to limit the driving of the autonomous vehicle based on the analysis results.

For example, the first limiting mode may be a normal mode. As shown in FIGS. 5A and 5B, in the first limiting mode, a required acceleration may be a0, and FCA may be an initial TTC. The second limiting mode may be a partially limiting mode. In the second limiting mode, a required acceleration may be a1, and FCA may be TTC 1. The second limiting mode may be a partially limiting mode. In the second limiting mode, a required acceleration may be a2, and FCA may be TTC 2.

A required acceleration is expressed as “a0, a1, a2, a* . . . ” and may be set as a configurable value, and may be linked to an eco mode, a normal mode, a sport mode, a sport+ mode, and the like of the autonomous vehicle.

In addition, TTC is expressed as “t0, t1, t2 . . . ” and may be set as a configurable value.

For example, under the control of the processor, the autonomous vehicle may set the first limiting mode when a measured inter-vehicle distance is less than or equal to the first safety distance at S23. The autonomous vehicle may maintain a required acceleration or current TTC (e.g., initial TTC, or exiting TTC) based on the set first limiting mode under the control of the processor at S24.

A new TTC or a changed TTC can be expressed as Equation 2 below.

$$T T C ( new ) = T T C ( existing ) ( 1 + a \% ) \qquad [ Equation 2 ]$$

In Equation 2, “a” may be an integer and a configurable value.

In addition, under the control of the processor, the autonomous vehicle may set the second limiting mode when a measured inter-vehicle distance is greater than the first safety distance and is less than or equal to the second safety distance at S25.

Under the control of the processor, the autonomous vehicle may change a required acceleration based on the set second limiting mode or may switch to a first time to collision so that a braking control time is ahead of the current TTC at S26.

In addition, under the control of the processor, the autonomous vehicle may set a third limiting mode when a measured inter-vehicle distance is greater than the second safety distance. Under the control of the processor, the autonomous vehicle may change a required acceleration based on the set third limiting mode or may switch to a second time to collision so that a braking control time is ahead of the first time to collision.

In addition, under the control of the processor, the autonomous vehicle may turn off the SCC mode while switching to the second time to collision based on the set third limiting mode at S27.

Under the control of the processor, the autonomous vehicle may allow an alarm regarding inspection and replacement of its own tires to be output.

The autonomous vehicle may control its own driving based on a set limiting mode under the control of the processor.

As described above, under the control of the processor, when the SCC mode has been turned on, the autonomous vehicle according to the second embodiment of the present disclosure may measure the distance between itself and a vehicle ahead after having stopped and may change a required acceleration, TTC, and the like for the SCC or a navigation-based SNN (NSCC) for each condition by comparing a measured inter-vehicle distance with an average inter-vehicle distance, a minimum inter-vehicle distance, and the like. In some cases, the autonomous vehicle may disable or limit the operation of the SCC when necessary.

Under the control of the processor, the autonomous vehicle may determine how a road surface is by comparing an inter-vehicle distance measured when the autonomous vehicle has stopped under the condition of the same SCC required acceleration with a preset safety distance.

For example, under the control of the processor, the autonomous vehicle may compare a SCC post-stopping average inter-vehicle distance (Navg), under the condition of the same required acceleration value, with a SCC post-stopping minimum inter-vehicle distance (N) in a normal range. Under the control of the processor, the autonomous vehicle may determine that a road surface is slippery or its tires are worn when an average value of an inter-vehicle distance (Navg) approaches or becomes shorter than a post-stopping minimum inter-vehicle distance (N).

Under the control of the processor, the autonomous vehicle may change a SCC required acceleration, a SCC required deceleration, and the like and increase FCA TTC, thereby advancing a braking control time compared to an existing braking control time to secure a normal stopping distance.

Accordingly, it may be possible for the autonomous vehicle to ensure a driver's safety by limiting the operation of the SCC under the control of the processor.

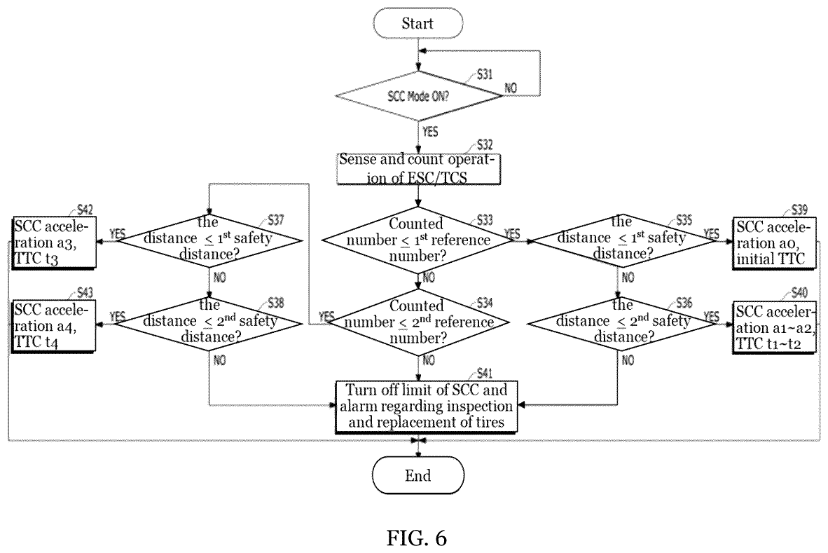

FIG. 6 is a view for illustrating a method of driving an autonomous vehicle according to a third embodiment of the present disclosure.

Referring to FIG. 6, a method of controlling the autonomous vehicle including a processor according to the third embodiment of the present disclosure is as follows.

The autonomous vehicle may determine whether a smart cruise control (SCC) mode has been turned on while driving under the control of a processor at S31.

When the smart cruise control (SCC) mode is turned on while the autonomous vehicle is traveling, the autonomous vehicle may sense and count the operation of an advanced driver assistance system (ADAS), under the control of a processor at S32.

The advanced driver assistance system (ADAS) may include an electronic stability control (ESC) or a traction control system (TCS).

When the smart cruise control (SCC) mode is turned on while the autonomous vehicle is traveling, under the control of the processor, the autonomous vehicle may sense the operations of the ESC or the TCS and may count and accumulate the sensed operations of the ESC or the TCS.

Under the control of the processor, the autonomous vehicle may compare the number of counted times the ADAS is operated with a reference number, which has been preset, and may set a limiting mode to limit the driving of the autonomous vehicle based on the comparison result at S33 and S34.

Under the control of the processor, the autonomous vehicle may determine whether a measured inter-vehicle distance is less than or equal to a first safety distance at S35 when the number of times the ADAS is operated is less than or equal to a first reference number at S33.

When the measured inter-vehicle distance is less than or equal to the first safety distance at S35, under the control of the processor, the autonomous vehicle may set a first limiting mode at S39. The autonomous vehicle may maintain a required acceleration or a current time to collision (TTC) based on the set first limiting mode under the control of the processor at S39.

When the number of times the ADAS is operated is less than or equal to the first reference number at S33 and a measured inter-vehicle distance is greater than the first safety distance and is less than or equal to a second safety distance, the autonomous vehicle may set a second limiting mode under the control of the processor at S36.

Under the control of the processor, the autonomous vehicle may change a required acceleration based on the set second limiting mode or may switch to a first time to collision so that a braking control time is ahead of the current time to collision (TTC) at S40.

When a measured inter-vehicle distance is greater than the second safety distance, under the control of the processor, the autonomous vehicle may turn off a SCC mode and allow an alarm regarding inspection and replacement of its own tires to be output at S41.

In addition, when the number of times the ADAS is operated is greater than the first reference number and is less than or equal to the second reference number at S34, under the control of the processor, the autonomous vehicle may determine whether a measured inter-vehicle distance is less than or equal to the first safety distance at S37.

Under the control of the processor, the autonomous vehicle may set a third limiting mode at S42 when a measured inter-vehicle distance is less than or equal to the first safety distance at S37. Under the control of the processor, the autonomous vehicle may change a required acceleration or switch to a third TTC based on the set third limiting mode at S43.

When the number of times the ADAS is operated is less than or equal to the second reference number at S34 and a measured inter-vehicle distance is greater than the first safety distance and is less than or equal to the second safety distance, the autonomous vehicle may set a fourth limiting mode under the control of the processor at S38.

Under the control of the processor, the autonomous vehicle may change a required acceleration or switch to a fourth TTC based on the set fourth limiting mode at S43.

In addition, when a measured inter-vehicle distance is greater than the second safety distance, under the control of the processor, the autonomous vehicle may turn off the SCC mode and allow an alarm regarding inspection and replacement of its own tires to be output at S41.

The autonomous vehicle may control its own driving based on a set limiting mode under the control of the processor.

As described above, when the SCC mode has been turned on, under the control of the processor, the autonomous vehicle according to the third embodiment of the present disclosure may check the accumulated numbers of times the ESC or the TCS is operated, may compare average values of SCC post-stopping inter-vehicle distances of the accumulated numbers of times the ESC or the TCS is operated, and may change (decrease) a SCC acceleration and change (increase) TTC depending on their respective conditions based on the comparison results.

Since the ESC or the TCS is occurred under the control of the processor in the case of the autonomous vehicle, it may be possible to secure safety in terms of distance between vehicles compared to a conventional logic.

The present disclosure, which has been described above, can be carried out as a computer-readable code on a program-recorded medium. Examples of a computer-readable medium include all types of recording devices that store data that can be read by a computer system, such as a hard disk drive (HDD), a solid-state disk (SSD), a silicon disk drive (SDD), a read-only memory (ROM), a random access memory (RAM), a compact disc ROM (CD-ROM), a magnetic tape, a floppy disk, and an optical data storage device.

Accordingly, the detailed description should not be construed as restrictive in any respect but as illustrative. The scope of the present disclosure should be determined based on reasonable interpretation of the appended claims, and all changes within the scope of the present disclosure are included in the scope thereof.

What is claimed is:

1. A method of controlling a vehicle, the method comprising:
determining, by a controller, that a first condition or a second condition is satisfied while the vehicle is controlled in a smart cruise control (SCC); and
controlling, by the controller, driving of the vehicle in a set limiting mode for the first condition or the second condition.

2. The method of claim 1, wherein the first condition includes a condition that another advanced driver assistance system (ADAS) control is operated in a number of times equal to or over a predetermined reference number.

3. The method of claim 2, wherein the other ADAS control includes an electronic stability control (ESC) or a traction control system (TCS).

4. The method of claim 2, wherein:
the predetermined reference number includes a first reference number and a second reference number; and
the set limiting mode comprises a first limiting mode, a second limiting mode, or a third limiting mode based on the first reference number and the second reference number.

5. The method of claim 4, wherein controlling the driving of the vehicle in the set limiting mode comprises:
controlling the vehicle in the first limiting mode when the number of times is less than or equal to the first reference number; and
maintaining a determined acceleration or a time to collision (TTC) based on the set first limiting mode.

6. The method of claim 5, wherein controlling the driving of the vehicle comprises:
controlling the vehicle in the second limiting mode when the number of times is greater than the first reference number and is less than or equal to the second reference number; and
changing the determined acceleration based on the set second limiting mode or switching to a first TTC so that a braking control time is ahead of the TTC.

7. The method of claim 6, wherein controlling the driving of the vehicle comprises:
controlling the vehicle in the third limiting mode when the number of times is greater than the second reference number; and
changing the determined acceleration based on the set third limiting mode or switching to a second TTC so that the braking control time is ahead of the first TTC.

8. The method of claim 6, wherein controlling the driving of the vehicle further comprises:
turning off the SCC; and
outputting an alarm regarding inspection and replacement of tires based on the third limiting mode.

9. The method of claim 1, wherein the second condition includes a condition that, when the vehicle stops in the SCC, a distance between the vehicle and another vehicle ahead of the vehicle is equal to or smaller than a predetermined reference safety distance.

10. The method of claim 9, wherein:
the predetermined reference safety distance includes a first safety distance and a second safety distance; and
the set limiting mode comprises a first limiting mode, a second limiting mode, or a third limiting mode based on the first safety distance and the second safety distance.

11. The method of claim 10, wherein controlling the driving of the vehicle in the set limiting mode comprises:
controlling the vehicle in the first limiting mode when the distance is less than or equal to the first safety distance; and
maintaining a determined acceleration or a time to collision (TTC) based on the set first limiting mode.

12. The method of claim 11, wherein controlling the driving of the vehicle in the set limiting mode comprises:
controlling the vehicle in the second limiting mode when the distance is greater than the first safety distance and is less than or equal to the second safety distance; and
changing the determined acceleration based on the set second limiting mode or switching to a first TTC so that a braking control time is ahead of the TTC.

13. The method of claim 12, wherein controlling the driving of the vehicle in the set limiting mode comprises:
controlling the vehicle in the third limiting mode when the distance is greater than the second safety distance; and
changing the determined acceleration based on the set third limiting mode or switching to a second TTC so that the braking control time is ahead of the first TTC.

14. The method of claim 13, wherein controlling the driving of the vehicle in the set limiting mode comprises:
turning off the SCC; and
outputting an alarm regarding inspection and replacement of tires.

15. A vehicle comprising:
a sensor module configured to sense environment around the vehicle;
an advanced driver assistance system (ADAS) configured to implement ADAS controls including a smart cruise control (SCC); and
a controller configured to control the sensor module and the ADAS,
wherein the controller is further configured to determine that a first condition or a second condition is satisfied while the vehicle is controlled in the SCC and to control driving of the vehicle in a set limiting mode for the first condition or the second condition.

16. The vehicle of claim 15, wherein the first condition includes a condition that another ADAS control is operated in a number of times equal to or over a predetermined reference number.

17. The vehicle of claim 16, wherein the other ADAS control includes an electronic stability control (ESC) or a traction control system (TCS).

18. The vehicle of claim 17, wherein the controller is further configured to control the vehicle in the first limiting mode when the number of times is less than or equal to the first reference number and to maintain a determined acceleration or a time to collision (TTC) based on the set first limiting mode.

19. The vehicle of claim 16, wherein:
the predetermined reference number includes a first reference number and a second reference number; and
the set limiting mode comprises a first limiting mode, a second limiting mode, or a third limiting mode based on the first reference number and the second reference number.

20. The vehicle of claim 15, wherein the second condition includes a condition that, when the vehicle stops in the SCC, a distance between the vehicle and another vehicle ahead of the vehicle is equal to or smaller than a predetermined reference safety distance.
